(19) United States
(12) Patent Application Publication
(10) Pub. No.: US 2026/0303517 A1
(43) Pub. Date: Oct. 1, 2026

(54) METHODS, SYSTEMS, AND COMPUTER READABLE MEDIA FOR PROVIDING HIERARCHICAL SECURITY EDGE PROTECTION PROXY (SEPP) DEPLOYMENT FOR ROAMING HUB USING SERVICE COMMUNICATION PROXY (SCP)-BASED MODEL D ROUTING

(71) Applicant: Oracle International Corporation, Redwood Shores, CA (US)

(72) Inventor: Yesh Goel, Bangalore (IN)

(21) Appl. No.: 19/094,698

(22) Filed: Mar. 28, 2025

(51) Int. Cl. H04L 45/28; H04L 9/40; H04L 41/0823; H04L 67/564

(52) U.S. Cl. CPC H04L 45/28; H04L 41/0823; H04L 63/0281; H04L 67/564

(57) ABSTRACT

A method for providing a hierarchical SEPP deployment for a roaming hub using SCP-based model D routing includes registering, by SEPP instances and with an NRF instance in a combined roaming hub, NRF, and SCP deployment including the SEPP instances, the NRF instance and an SCP instance, NF profiles of the SEPP instances. The NF profiles each include a list of identifier(s) of PLMN(s) reachable through a registering SEPP instance. The SEPP instances heart-beat with the NRF instance. The method further includes obtaining, by the SCP instance and from the NRF instance, NF profiles of the SEPP instances in the combined roaming hub, NRF, and SCP deployment. The method further includes using, by the SCP instance, the NF profiles of the SEPP instances, including the lists of identifiers of PLMNs reachable through the SEPP instances, to route SBI request messages between the SEPP instances according to 3GPP communication model D.

### TECHNICAL FIELD

The subject matter described herein relates to roaming hubs in 3GPP core networks. More particularly, the subject matter described herein relates to methods, systems, and computer readable media for providing a hierarchical SEPP deployment for a roaming hub using SCP-based model D routing.

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is a service instance of a producer NF that provides one or more services. A given producer NF may include more than one NF service instance. It should also be noted that multiple NF service instances can share the same service endpoint.

NFs register with an NF repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the types of services provided by an NF instance as well as contact and capacity information regarding the NF instance.

SCPs route messages between NF instances. An SCP can also invoke the NF discovery service operation to learn about available NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instance.

SEPPs forward service-based interface (SBI) messages between public land mobile networks (PLMNs) and perform security functions for inter-PLMN message traffic. A roaming hub is a collection of SEPPs connected in a mesh configuration to provide services to mobile network operators (MNOs), such as routing messages between PLMNs operated by different MNOs. One problem with roaming hub deployments is, because the roaming hub is not standardized, there is no standard mechanism for SEPP instances within the roaming hub to route messages to other SEPP instances within and outside of the roaming hub.

Accordingly, in light of these and other difficulties, there exist a need for improved methods, systems, and computer readable media for deploying a roaming hub and for routing messages between SEPP instances within and outside of the roaming hub.

### SUMMARY

A method for providing a hierarchical SEPP deployment for a roaming hub using SCP-based Third Generation Partnership Project (3GPP) communication model D routing includes registering, by SEPP instances and with NRF instance in a combined roaming hub, NRF, and SCP deployment that includes the SEPP instance, the NRF instance, and an SCP instance, NF profiles of the SEPP instances, wherein the NF profiles each include a list of identifiers of at least one PLMN reachable through a registering SEPP instance. The method further includes heart-beating, by the SEPP instances and with the NRF instance. The method further includes obtaining, by the SCP instance and from the NRF instance, NF profiles of the SEPP instances in the combined roaming hub, NRF, and SCP deployment. The method further includes using, by the SCP instance, the NF profiles of the SEPP instances, including the lists of identifiers of at least one PLMN reachable through the SEPP instances, to route SBI request messages between the SEPP instances according to 3GPP communication model D.

According to another aspect of the subject matter described herein, the SCP instance is dedicated to routing messages between the SEPP instances of the roaming hub.

According to another aspect of the subject matter described herein, registering with the NRF instance includes transmitting, by the SEPP instances, NF register request messages to the NRF instance and the NF register request messages each include a SeppInfo attribute containing the list of at least one identifier of at least one PLMN reachable through a registering SEPP instance.

According to another aspect of the subject matter described herein, heart-beating with the NRF instance includes transmitting, by the SEPP instances, NF heart-beat request messages to the NRF instance and the NF heart-beat request messages each carry information indicative of a current processing load of a heart-beating SEPP instance.

According to another aspect of the subject matter described herein, obtaining the NF profiles of the SEPP instances deployed within the roaming hub includes transmitting, by the SCP instance, an NF list retrieval request message to the NRF instance; receiving, by the SCP instance and from the NRF instance, an NF list retrieval response message including a list of identifiers of the SEPP instances within the combined roaming hub, NRF, and SCP deployment; transmitting, by the SCP instance and to the NRF instance, an NF profile retrieval request message including the list of identifiers of SEPP instances; and receiving, by the SCP instance and from the NRF instance, NF profiles of the SEPP instances identified in the list.

According to another aspect of the subject matter described herein, the method for providing a hierarchical SEPP deployment for a roaming hub using SCP-based model D routing includes receiving, by the SCP instance, an SBI request message addressed to a target PLMN, wherein obtaining the NF profiles of the SEPP instances includes transmitting, by the SCP instance and to the NRF instance, an NF discovery request message including a query parameter identifying the target PLMN, receiving, by the SCP instance and from the NRF instance, an NF discovery response message, and reading, by the SCP instance and from the NF discovery response message, an NF profile of at least one of the SEPP instances through which the target PLMN is reachable, and using the NF profiles to intelligently route SBI request messages includes reading the list of at least one identifier of at least one PLMN in the NF profile received in the NF discovery response message and forwarding the SBI request message to a SEPP instance through which the target PLMN is reachable.

According to another aspect of the subject matter described herein, the method for providing a hierarchical SEPP deployment for a roaming hub using SCP-based model D routing includes obtaining, by SCP instances, NF profile updates of the SEPP instances.

According to another aspect of the subject matter described herein, the method for providing a hierarchical SEPP deployment for a roaming hub using SCP-based model D routing includes obtaining the NF profile updates includes subscribing, by the SCP instance and with the NRF instance, to receive notification of updates of NF profile changes of the SEPP instances and receiving, from the NRF instance, notifications of changes in the NF profiles of the SEPP instances.

According to another aspect of the subject matter described herein, subscribing with the NRF instance includes transmitting, by the SCP instance, an NF status subscribe request message to the NRF instance, the NF status subscribe request message identifying an NF type of SEPP for subscribing to receive notifications of the NF profile updates of the SEPP instances.

According to another aspect of the subject matter described herein, the method for providing a hierarchical SEPP deployment for a roaming hub using SCP-based 3GPP communication model D routing includes receiving, by the SCP instance, an NF status notify request message indicating that a SEPP instance of the SEPP instances has a SUSPENDED state, and marking, by the SCP instance, an NF profile of the SEPP instance stored by the SCP instance to indicate that the SEPP instance that has a SUSPENDED state.

According to another aspect of the subject matter described herein, a system for providing a hierarchical SEPP deployment for a roaming hub using SCP-based 3GPP communication model D routing is provided. The system includes a combined roaming hub, NRF, and SCP deployment including at least one processor. The system further includes a plurality of SEPP instances, an NRF instance, and an SCP instance implemented by the at least one processor. The SEPP instances register, with the NRF instance, NF profiles of the SEPP instances, wherein the NF profiles each include a list of at least one identifier of at least one PLMN reachable through a registering SEPP instance. The SEPP instances heart-beat with the NRF instance. The SCP instance obtains, from the NRF instance, NF profiles of the SEPP instances in the combined roaming hub, NRF, and SCP deployment and uses the NF profiles of the SEPP instances, including the lists of at least one identifier of at least one PLMN reachable through the SEPP instances, to route SBI request messages between the SEPP instances according to 3GPP communication model D.

According to another aspect of the subject matter described herein, the SCP instance is dedicated to routing messages between the SEPP instances of the roaming hub.

According to another aspect of the subject matter described herein, the SEPP instances are configured to register with the NRF instance by transmitting NF register request messages to the NRF instance and the NF register request messages each include a SeppInfo attribute containing the list of at least one identifier of at least one PLMN reachable through a registering SEPP instance.

According to another aspect of the subject matter described herein, the SEPP instances are configured to heart-beat with the NRF instance by transmitting NF heart-beat request messages to the NRF instance and the NF heart-beat request messages each carry information indicative of a current processing load of a heart-beating SEPP instance.

According to another aspect of the subject matter described herein, the SCP instance is configured to obtain the NF profiles of the SEPP instances deployed within the roaming hub by transmitting an NF list retrieval request message to the NRF instance, receiving, from the NRF instance, an NF list retrieval response message including a list of identifiers of the SEPP instances within the combined roaming hub, NRF, and SCP deployment, transmitting, to the NRF instance, an NF profile retrieval request message including the list of identifiers of SEPP instances; and receiving, from the NRF instance, NF profiles of the SEPP instances identified in the list.

According to another aspect of the subject matter described herein the SCP instance is configured to receive an SBI request message addressed to a target PLMN and obtain the NF profiles of the SEPP instances by transmitting, to the NRF instance, an NF discovery request message including a query parameter identifying the target PLMN, receiving, from the NRF instance, an NF discovery response message, and reading from the NF discovery response message, an NF profile of at least one of the SEPP instances through which the target PLMN is reachable. The SCP instance is configured to use the NF profiles to intelligently route SBI request messages by reading the list of at least one identifier of at least one PLMN in the NF profile received in the NF discovery response message and forwarding the SBI request message to a SEPP instance through which the target PLMN is reachable.

According to another aspect of the subject matter described herein the SCP instance is configured to obtain NF profile updates of the SEPP instances.

According to another aspect of the subject matter described herein, the SCP instance is configured to obtain the NF profile updates by subscribing, with the NRF instance, to receive notification of updates of NF profile changes of the SEPP instances and receiving, from the NRF instance, notifications of changes in the NF profiles of the SEPP instances.

According to another aspect of the subject matter described herein the SCP instance is configured to receive an NF status notify request message indicating that a SEPP instance of the SEPP instances has a SUSPENDED state, and marking, by the SCP instance, an NF profile of the SEPP instance stored by the SCP instance to indicate that the SEPP instance that has a SUSPENDED state.

According to another aspect of the subject matter described herein, a non-transitory computer readable medium having stored thereon executable instructions that when executed by a processor of a computer controls the computer to perform steps is provided. The steps include registering, by SEPP instances and with an NRF instance in a combined roaming hub, NRF, and SCP deployment including the SEPP instances, the NRF instance, and an SCP instance, NF profiles of the SEPP instances, wherein the NF profiles each include a list of at least one identifier of at least one PLMN reachable through a registering SEPP instance. The steps further include heart-beating, by the SEPP instances and with the NRF instance. The steps further include obtaining, by the SCP instance and from the NRF instance, NF profiles of the SEPP instances in the combined roaming hub, NRF, and SCP deployment. The steps further include using, by the SCP instance, the NF profiles of the SEPP, including the lists of at least one identifier of at least one PLMN reachable through the SEPP instances, to route SBI request messages between the SEPP instances according to 3GPP communication model D.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer-readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a block diagram illustrating an exemplary roaming hub deployment;

FIG. 3 is a block diagram illustrating an example combined roaming hub NRF, and SCP deployment;

FIG. 4 is a message flow diagram illustrating exemplary messages for the NF register and NF heart-beat service operations within a combined roaming hub, NRF, and SCP deployment;

FIG. 5 is a message flow diagram illustrating exemplary messages for the NF list and profile retrieval service operations within a combined roaming hub NRF, and SCP deployment;

FIG. 6 is a message flow diagram illustrating exemplary messages for the NF discovery operation within a combined roaming hub, NRF, and SCP deployment;

FIG. 7 is a message flow diagram illustrating exemplary messages for the NF subscribe and notify service operations within a combined roaming hub, NRF, and SCP deployment;

FIG. 8 is a block diagram illustrating an exemplary architecture for a combined roaming hub NRF, and SCP deployment; and

FIG. 9 is a flow chart illustrating an exemplary process for providing a hierarchical SEPP deployment for a roaming hub using SCP-based 3GPP communication model D routing.

### DETAILED DESCRIPTION

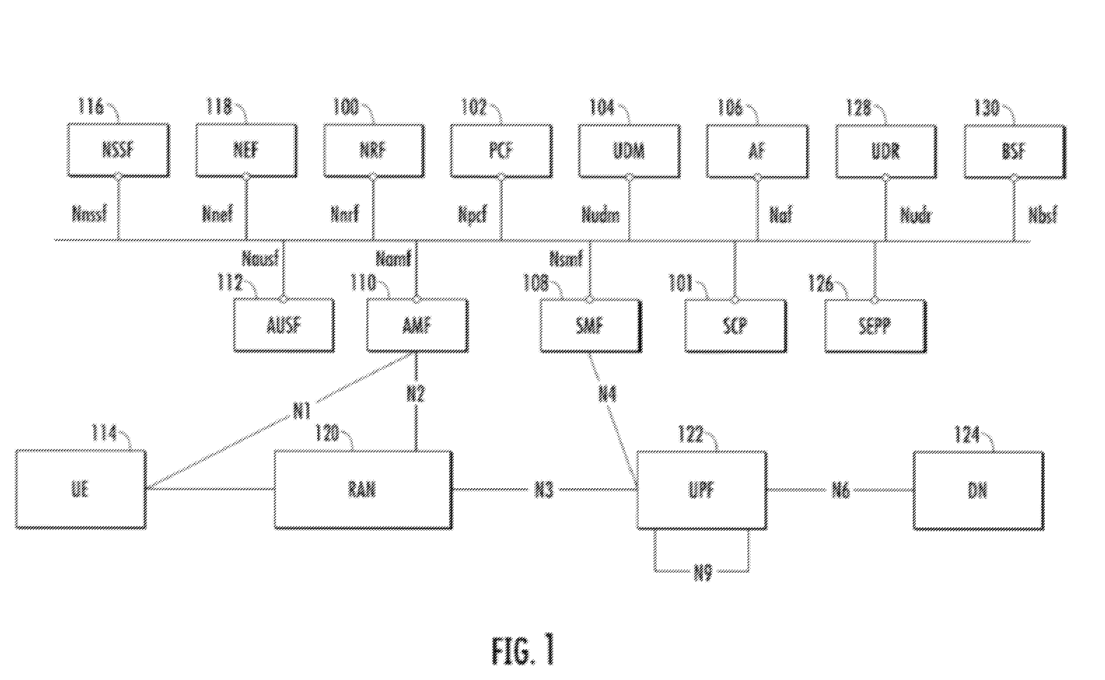

FIG. 1 is a network diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the types of services provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 provides authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

A SEPP 126 filters incoming traffic from another PLMN and can perform topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A SEPP filtering egress messages from consumer NFs in a PLMN is referred to as a consumer SEPP or C-SEPP. A SEPP that filters ingress messages directed to producer NFs in a PLMN is referred to as a producer SEPP or P-SEPP. A given SEPP can function as a C-SEPP and a P-SEPP, depending on the role the SEPP is performing.

A unified data repository (UDR) 128 stores subscription data for UEs. A binding support function (BSF) 130 manages bindings between PDU sessions and PCFs.

As stated above, a roaming hub is a collection of SEPP instances connected in a mesh configuration and configured to provide services to MNOs. Functions and operations that may be provided by a roaming hub include remote value-added services (RVAS), routing, filtering, testing, troubleshooting, billing, invoicing, and dispute management. The roaming hub provides interconnection for 5G inter-PLMN SBI routing between MNOs through SEPP instance deployments, where each SEPP instance functions as a hypertext transfer protocol (HTTP/2) proxy. Multiple SEPP instances are required to be deployed in a roaming hub, given the number of client MNOs serving multiple PLMNs.

In a roaming hub, the SEPP instances are grouped to serve specific sets of PLMN Ids belonging to a set of client MNOs. The result is a mesh of SEPP instances where each SEPP instance is required to be aware of the following:
other SEPP instances within the roaming hub serving different PLMN Ids;
remote PLMN Ids and respective SEPP instances of the MNOs / mobile virtual network operators (MVNOs) / mobile virtual network enablers (MVNEs); and
SEPP instances of other roaming hubs.

When a request is received from another PLMN’s SEPP, the receiving SEPP instance determines which SEPP instance is serving the target PLMN (the serving SEPP instance may be the receiving SEPP instance) within the roaming hub deployment and then forwards the request to that SEPP instance. The SEPP instance serving the target PLMN receives the request and forwards the request to the target PLMN.

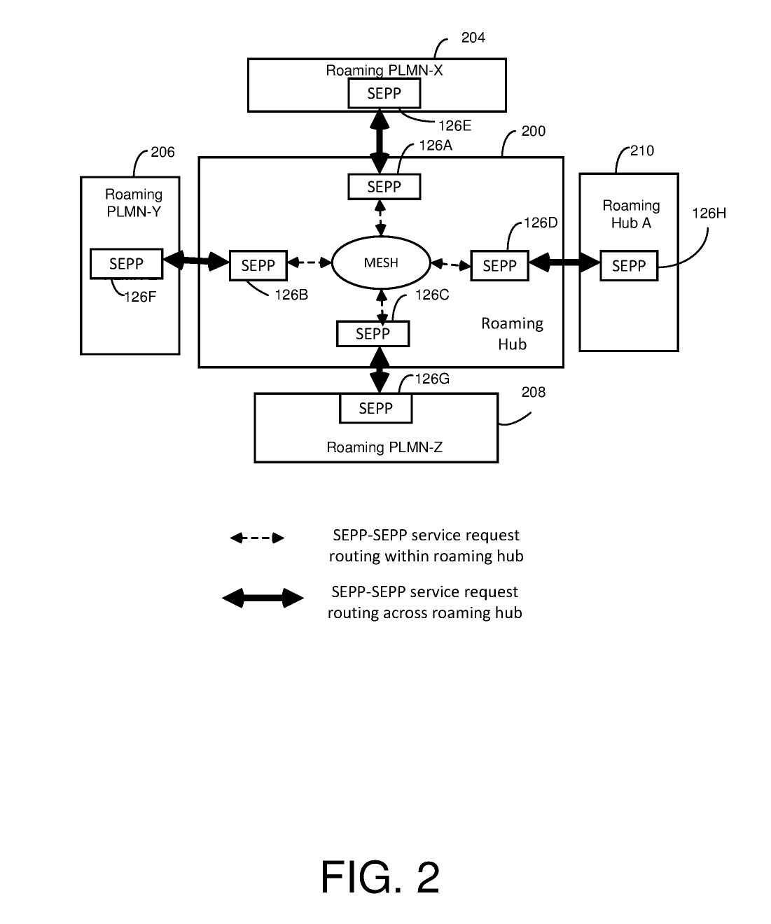

FIG. 2 is a block diagram illustrating an exemplary roaming hub deployment. In FIG. 2, a roaming hub 200 includes SEPP instances 126A-126D that provide services and route messages to different roaming PLMNs. In the illustrated example, SEPP instance 126A provides services and routes messages to roaming PLMN-X 204 and is connected to roaming PLMN-X 204 through SEPP instance 126E. SEPP instance 126B provides services and routes messages to roaming PLMN-Y 206 and is connected to roaming PLMN-Y 206 via SEPP instance 126F. SEPP instance 126C provide services and routes messages to roaming PLMN-Z 208 and is connected to roaming PLMN-Z 208 via SEPP instance 126G. SEPP instance 126D provides services and routes messages to a PLMN served by roaming hub 210 and is connected to SEPP instance 126H in roaming hub 210.

Roaming hub deployments, such as that illustrated in FIG. 2, provide a number of advantages. For example, roaming hubs connect multiple MNOs / MVNOs / MVNEs to extend their roaming services / coverage from a routing perspective. The roaming hub avoids the need for MNOs to have dedicated bilateral roaming agreements across all other operators, thus enabling better experiences for roaming subscribers. The roaming hub reduces the need for each service provider to connect with a wide range of roaming partners by setting up individual connections with each partner. The roaming hub enables operators to negotiate roaming deals and quickly initiate roaming services with partner networks.

Challenges associated with roaming hub deployments include the fact that there is no standards-defined roaming hub deployment architecture. In addition, with increased numbers of partner MNO PLMNs and increased roaming traffic, the number of roaming hub SEPP instances will increase, thus making the status of SEPPs connected in the roaming hub mesh configuration very difficult to manage at each roaming hub SEPP instance. Another challenge is operational inefficiency in manually maintaining route configurations for multiple PLMN Ids at individual SEPP instances of the roaming hub to enable the individual SEPP instances to select roaming hub SEPP instances or MNO SEPP instances for egress traffic. Manual mapping of MNO PLMN Ids to deployed SEPP instances of the roaming hub is inefficient. Moreover, there may be multiple SEPP instances which are part of same NF set and may serve as alternative SEPP instances when the primary configured SEPP instance has failed/become unresponsive (or, in 3GPP terminology, has become SUSPENDED). In such cases, each roaming hub SEPP instance must also be configured with NF set information for sets of SEPPs. Another challenge of roaming hub deployments is uneven roaming inter-PLMN signaling load distribution across SEPP instances of the roaming hub. Where possible, such uneven load distribution should be avoided.

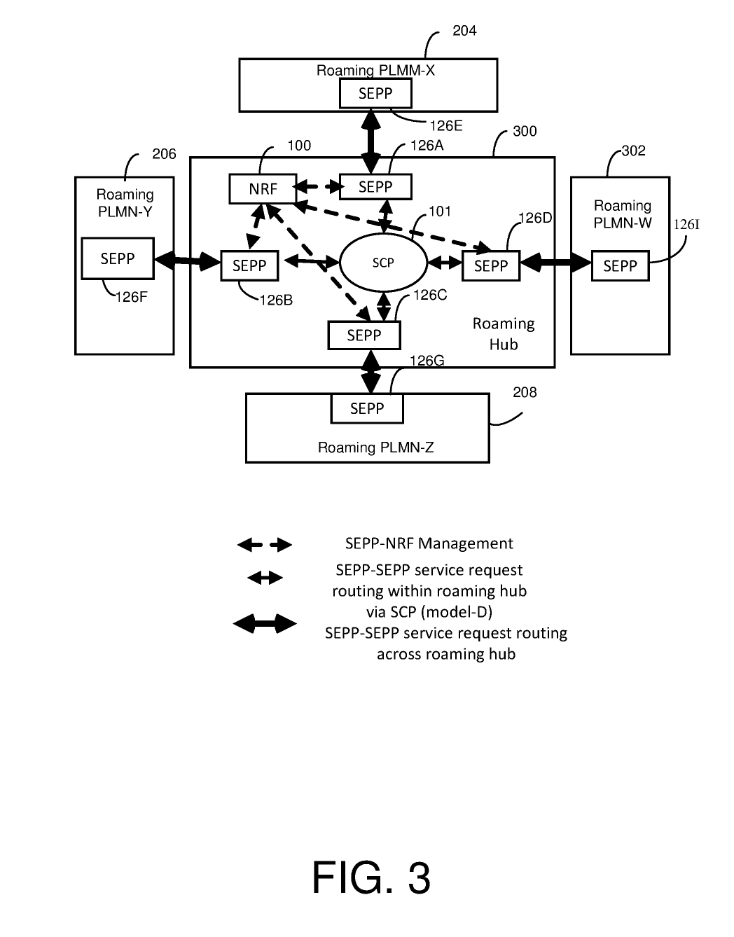

To address these and other challenges, an NRF instance and an SCP instance may be introduced within the roaming hub deployment to produce a combined roaming hub, NRF, and SCP deployment. FIG. 3 is a block diagram illustrating a combined roaming hub, NRF, and SCP deployment. Referring to FIG. 3, a combined roaming hub, NRF, and SCP deployment 300 includes SEPP instances 126A-126D, NRF instance 100, and SCP instance 101. NRF instance 100 is dedicated to SEPP instances 126A-126D, and NRF instance 100 may provide Nnrf management services, including any of the Nnrf management services defined in 3GPP TS 29.510, for SEPP instances 126A -126D and not to other NFs. In an alternate implementation, NRF instance 100 may be a shared NRF instance that provides Nnrf management services to NFs in addition to SEPP instances 126A-126D.

SCP instance 101 routes messages within roaming hub 300 between SEPP instances 126A-126D. SCP instance 101 may also perform delegated discovery on behalf of SEPP instances 126A-126D according to 3GPP communication model D. 3GPP communication model D is described in Annex E of 3GPP TS 23.501. 3GPP communication model D is one of the two indirect communication models in which the SCP performs SBI message routing on behalf of consumer NFs. In 3GPP communication model D, the SCP also performs NF discovery and selection on behalf of consumer NFs. As stated above, the case where the SCP performs NF discovery on behalf of consumer NFs is referred to as delegated discovery. In the architecture illustrated in FIG. 3, SCP instance 101 receives SBI request messages from SEPP instances 126A-126D, performs NF discovery with NRF instance 100 to identify the SEPP within roaming hub 300 to which the SBI request messages should be routed, and routes the SBI request messages to the selected SEPP instances within roaming hub 300. In one example, SCP instance 101 is dedicated to routing messages between SEPP instances 126A-126D within roaming hub 300. In an alternate example, SCP instance 101 may be a shared resource for routing messages between SEPPs within roaming hub 300 and routing messages between network functions that are not part of roaming hub 300.

In the illustrated example, each SEPP instance 126A-126D registers its NF profile with NRF instance 100. In addition, each SEPP instance 126A-126D may update its NF profile with NRF instance 100 by sending NF update request messages and NF heart-beat request messages to NRF instance 100. The NF profiles registered by each SEPP instance with NRF instance 100 may include a SeppInfo attribute that contains a remote PLMN list, which is a list of PLMN Ids of PLMNs reachable through each SEPP instance. Thus, by obtaining the NF profile information of SEPP instances within the roaming hub deployment, SCP instance 101 can use the lists of PLMN Ids reachable through each SEPP instance to route SBI request messages. For example, in the architecture illustrated in FIG. 3, if SEPP instance 126B receives an SBI request message from SEPP instance 126F, and the message indicates that the target PLMN is PLMN-W 302, SEPP instance 126B may forward the SBI request message to SCP instance 101, which performs NF discovery with NRF instance 100 to determine the target SEPP instances. SCP instance 101 may read the NF profiles of SEPP instances 126A, 126C, and 126D, determine, from the PLMN Id lists, that PLMN-W 302 is reachable through SEPP instance 126D, and forward the SBI request message to SEPP instance 126D. SEPP instance 126D may receive the SBI request message, determine that the message is directed to PLMN-W 302, determine that PLMN-W 302 is reachable via SEPP instance 126D (itself), and forward the SBI request message to SEPP instance 126I located in PLMN-W 302.

Each SEPP instance 126A-126D may heart-beat with NRF instance 100 (i.e., periodically transmit NF heart-beat request messages to NRF instance 100) to indicate the current processing load of each SEPP instance 126A-126D. NRF instance 100, in response to the NF heart-beat request messages, may update the NF profiles of SEPP instances 126A-126D to include the current processing load of SEPP instances 126A-126D, respectively. NRF instance 100 may maintain a status of each SEPP instance 126A-126D as REGISTERED (i.e., available) or SUSPENDED (i.e., unavailable), depending on whether the SEPP instance transmits its respective NF heart-beat request message within the associated NF heart-beat timeout interval.

Each SEPP instance 126A-126D, upon receiving an ingress SBI service request to route to a target PLMN, may add the following headers to the SBI request message:

3gpp-Sbi-Discovery-target-nf-type=SEPP; and

3gpp-Sbi-Discovery-remote-plmn-id header with the target PLMN id received in the 3gpp-Sbi-Target-Apiroot header in the ingress SBI request message destined for another PLMN.

After adding the headers, each SEPP instance 126A-126D may forward the SBI request messages to SCP instance 101 for delegated discovery and routing. The SCP profile of SCP instance 101 may be configured at each SEPP instance 126A-126D or learned through NF discovery with NRF instance 100.

SCP instance 101 may read the target NF type=SEPP from the 3gpp-Sbi-Discovery-target-nf-type header and the remote or target PLMN Id from the 3gpp-Sbi-Discovery-target-nf-type header of the SBI request message received from the SEPP. SCP instance 101 may query NRF instance 100 with consumer NF type=SEPP the remote PLMN Id as query parameters. The query message may, in one example, be an NF discovery request. NRF instance 100 receives the query message and responds with a list of SEPP identifiers of SEPPs serving he remote PLMN Id. SCP instance 101 receives, in the query response message from NRF 100, the list of SEPP identifiers serving the remote PLMN identified by the remote PLMN Id. The query response message may also include the SEPP profiles of the SEPPs identified in the list. SCP instance 101 selects one of the SEPP instances serving the PLMN identified by the remote PLMN Id and routes the SBI request to the selected SEPP instance. The SEPP instance within roaming hub 300 that receives the SBI request from SCP instance 101 forwards the SBI request to the SEPP instance associated with the target PLMN. The response message from the remote SEPP instance associated with the target PLMN follows the reverse path of the SBI request.

SCP instance 101 within roaming hub 300 may subscribe with NRF instance 100 to be notified of changes in status of SEPP instances 126A-126D within roaming hub 300. The subscription may be created by SCP instance 101 sending an NF status subscribe message to NRF instance 100 identifying NFType=SEPP for the subscription criteria. When the status, including processing loading, of any of SEPP instances 126A-126D changes, the SEPP instance experiencing the status change notifies NRF 100 by transmitting an NF update request message to NRF instance 100 containing details of the change in status. In response to the NF update request, NRF instance 100 updates the NF profile of the SEPP instance, and notifies SCP instance 101 of the change in status by transmitting an NF status notify request message to SCP instance 101. SCP instance 101 updates, in its local database or cache of NF profile information, the NF profile of the SEPP instance that experienced the change in status, and uses the updated NF profile information in performing SEPP selection for routing subsequent SBI requests. SCP instance 101 may also remove, from its local database or cache, data for any SEPP instances that are determined to be unavailable or SUSPENDED, thereby reducing the likelihood of message routing failures and retransmissions.

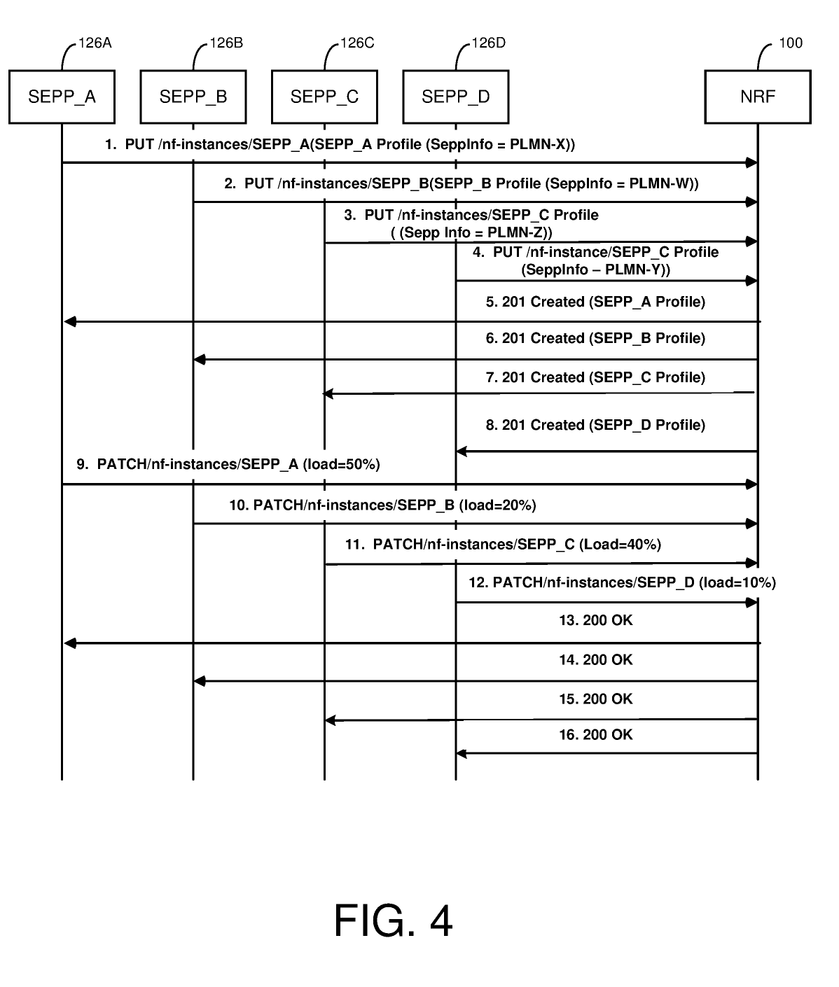

As indicated above, each SEPP instance may register its NF profile with NRF instance 100 and include, in its respective NF profile, a list of PLMN Ids reachable via each SEPP instance. FIG. 4 is a message flow diagram illustrating NF registration and subsequent heart-beating by SEPP instances 126A-126D with NRF instance 100. Referring to FIG. 4, in steps 1-4, SEPP instances 126A-126D register with NRF instance 100 by transmitting NF register request messages to NRF instance 100. The NF register request messages contain the SeppInfo attributes with the list of PLMN Ids reachable through each SEPP instance. In steps 5- 8, NRF instance 100 acknowledges the NF register request messages by sending 201 Created messages each carrying a resource identifier for the resource created on NRF instance 100.

In steps 9-12, SEPP instances 126A-126D heart-beat with NRF instance 100 by transmitting NF heart-beat request messages to NRF instance 100. The NF heart-beat request messages carry a value indicating the current processing load of each SEPP instance. In steps 13-16, NRF instance 100 acknowledges the NF heart-beat request messages. If NRF instance 100 fails to receive an NF heart-beat request message from one of SEPP instances 126A-126D within an NF heart-beat timeout interval defined by NRF instance 100, NRF instance 100 may mark the SEPP instance as SUSPENDED.

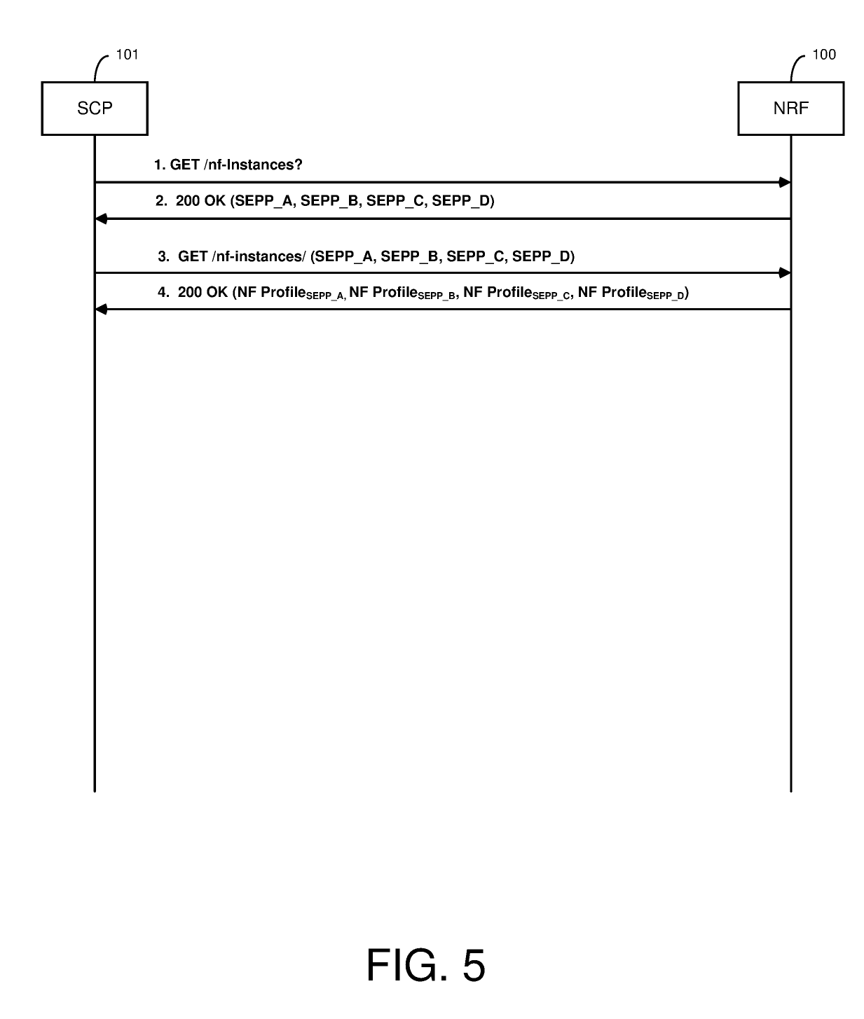

As indicated above, SCP instance 101 may obtain NF profile and load information of SEPP instances within the roaming hub deployment from NRF 101. Mechanisms for obtaining this information include NF list retrieval followed by NF profile retrieval, NF discovery, and NF status subscribe. FIG. 5 is a message flow diagram illustrating the use of the NF list retrieval and NF profile retrieval service operations by SCP instance 101 to obtain the NF profiles of SEPP instances 126A-126D. Referring to FIG. 5, in step 1, SCP 101 sends an NF list retrieval request message to NRF instance 100 requesting a list of all NF instances registered with NRF instance 100. In step 2, NRF instance 100 responds with a 200 OK message including a list of NF instance Ids of NFs registered with NRF instance 100. In the illustrated example, the list includes the NF instance Ids of SEPP instances 126A-126D. In step 3, SCP instance 101 sends an NF profile retrieval request to NRF instance 100. The NF profile retrieval request includes the NF instance Ids of SEPP instances 126A-126D. In step 4, NRF instance 100 responds with the NF profiles of SEPP instance 126A, SEPP instance 126B, SEPP instance 126C, and SEPP instance 126D.

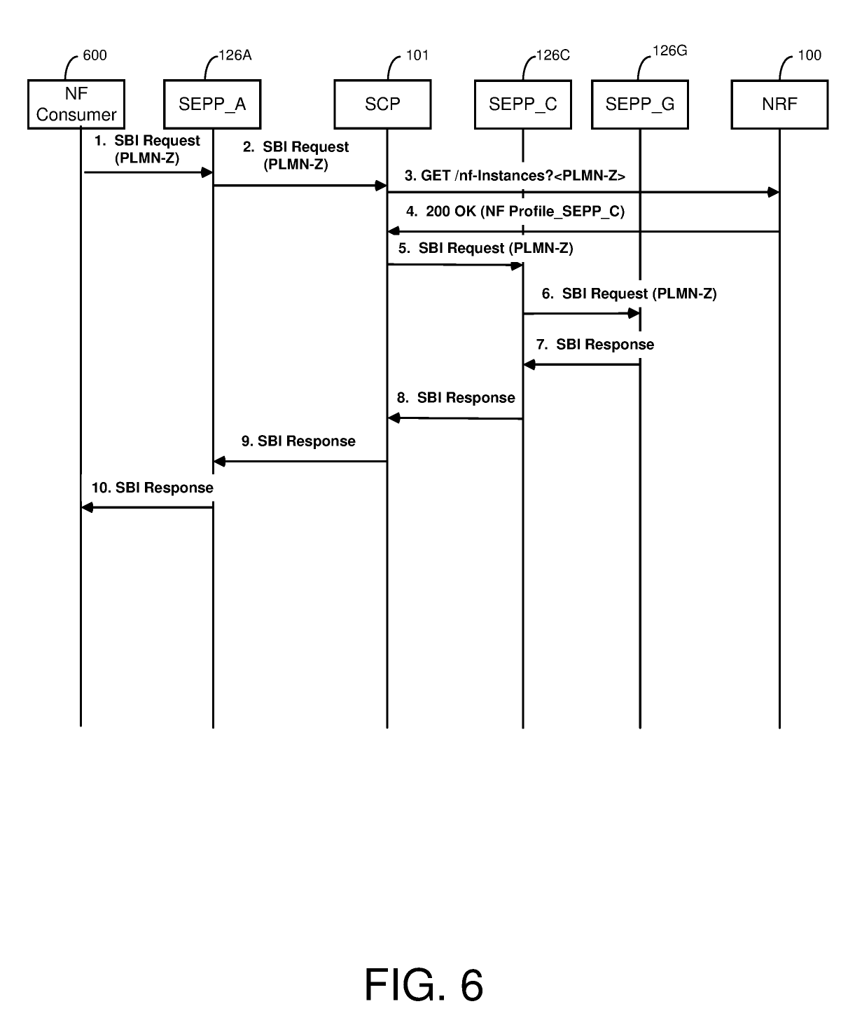

FIG. 6 is a message flow diagram illustrating the use of the NF discovery service operation by an SCP instance in a roaming hub to obtain an NF profile of an SEPP instance in the roaming hub. Referring to FIG. 6, in step 1, an NF service consumer sends an SBI request to SEPP instance 126A. SEPP instance 1126A receives the SBI request message, reads the remote PLMN Id of PLMN-Z from the 3gpp-Sbi-Target-apiroot header, adds a 3gpp-Sbi-Discovery-remote-plmn-id header to the message, and inserts that target PLMN Id of PLMN-Z in the added header. SEPP instance 126A also adds also adds a 3gpp-Sbi-Discovery-target-nf-type header to the message and inserts the value “SEPP” in the added header. In step 2, SEPP instance 126A forwards the updated SBI request message to SCP instance 101. SCP instance 101 receives the SBI request message addressed to an NF service producer in PLMN-Z. In step 3, SCP instance 101 sends an NF discovery request with the 3gpp-Sbi-Discovery-remote-plmn-id and to NRF instance 100 with the . In step 3, NRF instance 100 responds with a 200 OK message including the NF profile of SEPP instance 126C through which PLMN-Z can be reached. In step 4, SCP instance 101 forwards the SBI request message to SEPP instance 126C. In step 5, SBI SEPP 126C sends the SBI request message to SEPP instance 126G in PLMN-Z 208. In steps 7-10, the SBI response message follows the reverse path through the SEPP instances and SCP instance of the roaming hub and is ultimately delivered to NF service consumer 600.

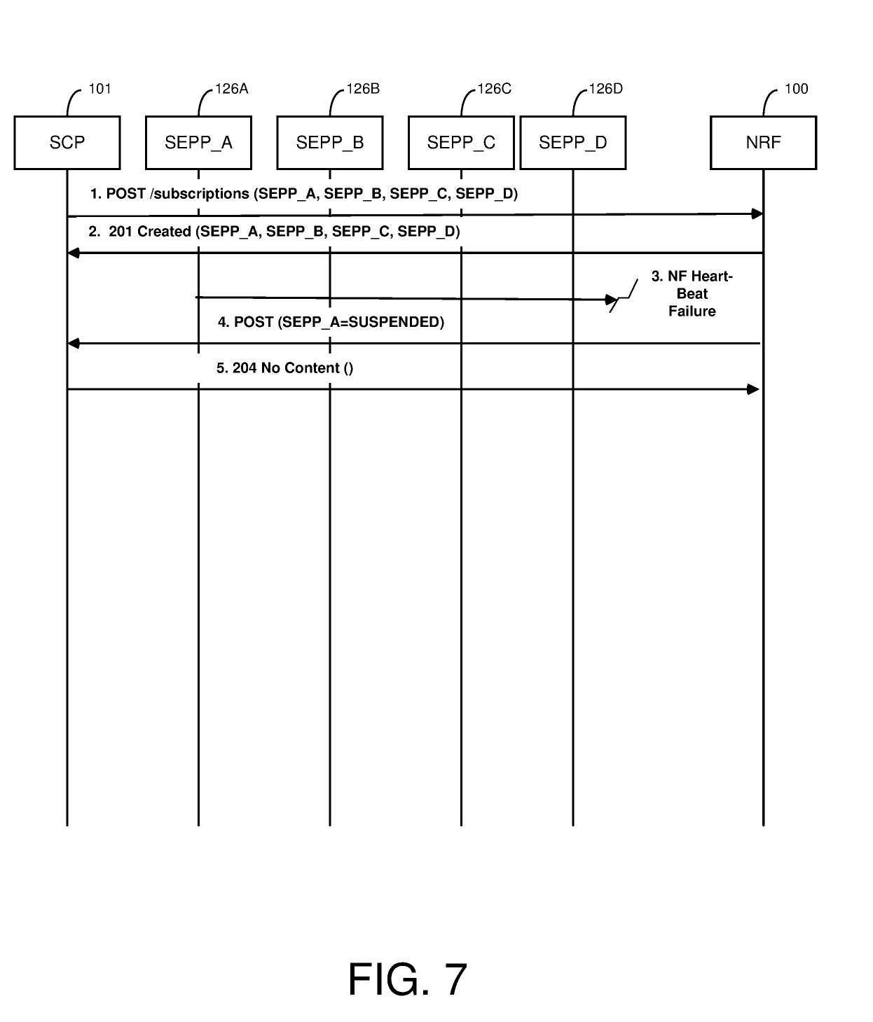

FIG. 7 is a message flow diagram illustrating the use of the NF status subscribe service operation by an SCP instance deployed in a roaming hub to receive updates of a change in status of an SEPP instance deployed within the roaming hub. Referring to FIG. 7, in step 1, SCP instance 101 sends an NF status subscribe request message to NRF instance 100 to subscribe to receive notification of changes in status of SEPP instances 126A, 126B, 126C, and 126D in the roaming hub deployment. In step 2, NRF instance 100 responds with a 201 Created message indicating that the subscription has been successfully created. In step 3, SEPP instance 126A fails to heart-beat with NRF instance 100. In step 4, NRF instance 100 sends an NF status notify request message to SCP instance 101 notifying SCP instance 101 that SEPP instance 126A has been marked as suspended. In step 5, SCP instance 101 responds with a 204 no content message.

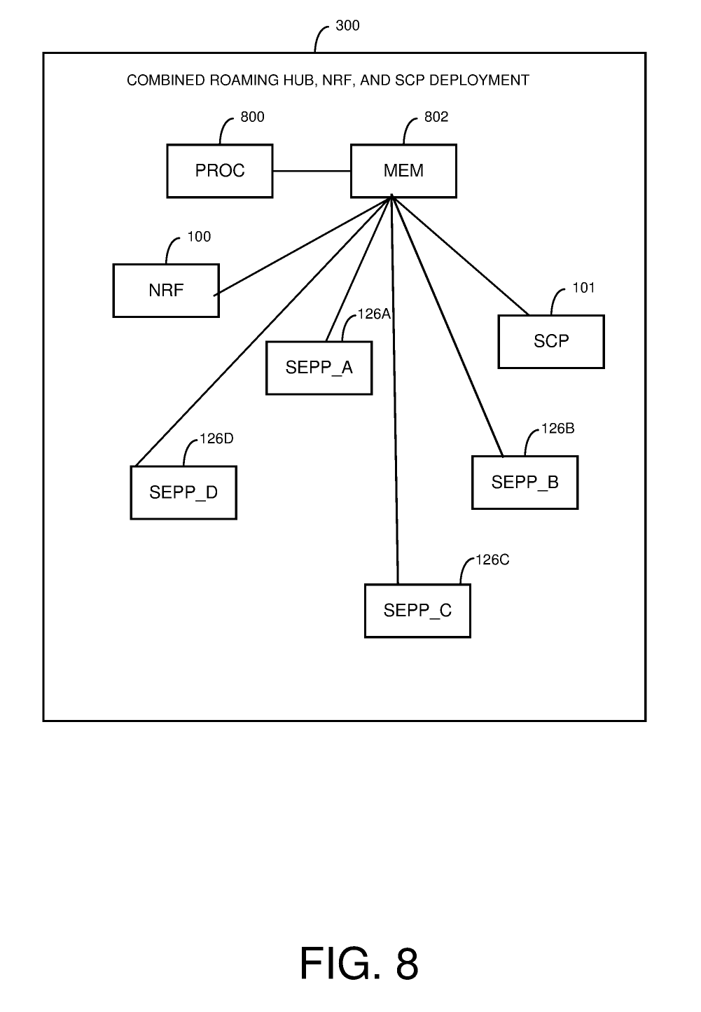

FIG. 8 is a block diagram illustrating an exemplary architecture for a combined roaming hub, NRF, and SCP deployment. Referring to FIG. 8, combined roaming hub, NRF, and SCP deployment 300 includes a computing platform including at least one processor 800 and memory 802. Combined roaming hub, NRF, and SCP deployment 300 includes NRF instance 100, SCP instance 101, and SEPP instances 126A-126D. NRF instance 100 provides the Nnrf management service operations to SEPP instances 126A-126D and SCP instance 101 as described above. SCP instance 101 performs delegated discovery with NRF instance 100 to learn the SEPP topology of roaming hub deployment 300 and routes messages between SEPP instances 126A-126D within roaming hub deployment 300. SEPP instances 126A-126D use SCP instance 101 for delegated discovery, maintaining current status of SEPP instances, and routing messages between the SEPP instances within combined roaming hub, NRF, and SCP deployment 300. NRF instance 100, SCP instance 101, and SEPP instances 126A-126D may be implemented using computer executable instructions stored in memory 802 and executed by processor 800.

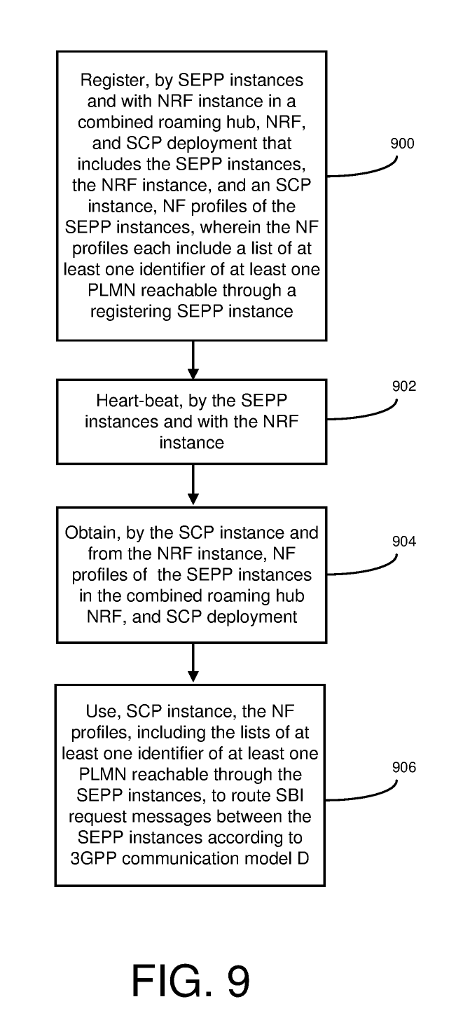

FIG. 9 is a flow chart illustrating an exemplary process for providing a hierarchical SEPP deployment for a roaming hub using SCP-based 3GPP communication model D routing. Referring to FIG. 9, in step 900, the process includes registering, by the SEPP instances and with the NRF instance, NF profiles of the SEPP instances, where the NF profiles each include a list of at least one identifier of at least one PLMN reachable through a registering SEPP instance. For example, the SEPP instances in the roaming hub may register with the NRF by transmitting NF register request messages to the NRF instances. For each registering SEPP instance, the NF profile in the NF register request message may include the list of PLMNs reachable through the SEPP instance.

In step 902, the process further includes heart-beating, by the SEPP instances and with the NRF instance. For example, each of the SEPP instances may transmit NF heart-beat request messages to the NRF instance to maintain an active registration status with the NRF instance.

In step 904, the process further includes obtaining, by the SCP instance and from the NRF instance, NF profiles of the SEPP instances in the combined roaming hub, NRF, and SCP deployment. For example, the SCP instance may obtain the NF profiles of SEPP instances in the roaming hub deployment using the NF list and profile retrieval service operations and the NF discover service operation.

In step 906, the process further includes using, by SCP instance, the NF profiles, including the lists of at least one identifier of at least one PLMN reachable through the SEPP instances, to route SBI request messages between the SEPP instances according to 3GPP communication model D. For example, the SCP instance, upon receiving an SBI request message, may determine a target PLMN identifier from the SBI request message, locate the NF profile of the SEPP instance through which the target PLMN is reachable, and forward the SBI request message to the identified SEPP instance.

Exemplary advantages of the subject matter described herein include using synergy among the SCP, NRF, and SEPP instances in a roaming hub deployment for early detection of SEPP failures and reducing the likelihood of routing reattempts. Another advantage of the subject matter described herein is reducing the need to manually configure SEPP instances in a roaming hub deployment with topology and status information of SEPP instances in the roaming hub deployment. Another advantage includes efficient routing of SBI request messages by avoiding routing of the SBI request messages to SUSPENDED SEPP instances in a roaming hub deployment. The methods and systems described herein enable load balancing to SEPP instances within the same NF set when the SEPP instances serve the same remote PLMNs. Such load balancing is facilitated by obtaining individual SEPP instance load and capacity information using the NF discovery and NF status subscribe service operations within the roaming hub. Yet another advantage of the subject matter described herein is facilitating scalability of roaming hub deployments by using an SCP instance to automatically discover and maintain topology and loading information regarding SEPP instances in the roaming hub deployments. When a new SEPP instance is added to a roaming hub deployment, the SCP instance can discover its existence using the NF profile list retrieval service operation and obtain its NF profile using the NF profile retrieval and/or NF discovery service operations.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.0.0 (2024-09)
2. 3^{rd} Generation Partnership Project; Technical Specification Group Services and System Aspects; System architecture for the 5G System (5GS); Stage 2 (Release 19) 3GPP TS 23.501 V19.2.1(2025-01)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing a hierarchical security edge protection proxy (SEPP) deployment for a roaming hub using service communication proxy (SCP)-based Third Generation Partnership Project (3GPP) communication model D routing, the method comprising:
registering, by SEPP instances and with an NRF instance in a combined roaming hub, NRF, and SCP deployment that includes the SEPP instances, the NRF instance, and an SCP instance, NF profiles of the SEPP instances, wherein the NF profiles each include a list of at least one identifier of at least one public land mobile network (PLMN) reachable through a registering SEPP instance;
heart-beating, by the SEPP instances and with the NRF instance;
obtaining, by the SCP instance and from the NRF instance, NF profiles of the SEPP instances in the combined roaming hub, NRF, and SCP deployment; and
using, by the SCP instance, the NF profiles of the SEPP instances, including the lists of at least one identifier of at least one PLMN reachable through the SEPP instances, to route SBI request messages between the SEPP instances according to 3GPP communication model D.

2. The method of claim 1 wherein the SCP instance is dedicated to routing messages between the SEPP instances of the roaming hub.

3. The method of claim 1 wherein registering with the NRF instance includes transmitting, by the SEPP instances, NF register request messages to the NRF instance and the NF register request messages each include a SeppInfo attribute containing the list of at least one identifier of at least one PLMN reachable through a registering SEPP instance.

4. The method of claim 1 wherein heart-beating with the NRF instance includes transmitting, by the SEPP instances, NF heart-beat request messages to the NRF instance and the NF heart-beat request messages each carry information indicative of a current processing load of a heart-beating SEPP instance.

5. The method of claim 1 wherein obtaining the NF profiles of the SEPP instances deployed within the roaming hub includes transmitting, by the SCP instance, an NF list retrieval request message to the NRF instance; receiving, by the SCP instance and from the NRF instance, an NF list retrieval response message including a list of identifiers of the SEPP instances within the combined roaming hub, NRF, and SCP deployment; transmitting, by the SCP instance and to the NRF instance, an NF profile retrieval request message including the list of identifiers of SEPP instances; and receiving, by the SCP instance and from the NRF instance, NF profiles of the SEPP instances identified in the list.

6. The method of claim 1 comprising receiving, by the SCP instance, an SBI request message addressed to a target PLMN, wherein obtaining the NF profiles of the SEPP instances includes:
transmitting, by the SCP instance and to the NRF instance, an NF discovery request message including a query parameter identifying the target PLMN;
receiving, by the SCP instance and from the NRF instance, an NF discovery response message, and reading, by the SCP instance and from the NF discovery response message, an NF profile of at least one of the SEPP instances through which the target PLMN is reachable; and
using the NF profiles to intelligently route SBI request messages includes reading the list of at least one identifier of at least one PLMN in the NF profile received in the NF discovery response message and forwarding the SBI request message to a SEPP instance through which the target PLMN is reachable.

7. The method of claim 1 comprising obtaining, by SCP instances, NF profile updates of the SEPP instances.

8. The method of claim 7 wherein obtaining the NF profile updates includes subscribing, by the SCP instance and with the NRF instance, to receive notification of updates of NF profile changes of the SEPP instances and receiving, from the NRF instance, notifications of changes in the NF profiles of the SEPP instances.

9. The method of claim 8 wherein subscribing with the NRF instance includes transmitting, by the SCP instance, an NF status subscribe request message to the NRF instance, the NF status subscribe request message identifying an NF type of SEPP for subscribing to receive notifications of the NF profile updates of the SEPP instances.

10. The method of claim 9 comprising receiving, by the SCP instance, an NF status notify request message indicating that a SEPP instance of the SEPP instances has a SUSPENDED state, and marking, by the SCP instance, an NF profile of the SEPP instance stored by the SCP instance to indicate that the SEPP instance that has a SUSPENDED state.

11. A system for providing a hierarchical security edge protection proxy (SEPP) deployment for a roaming hub using service communication proxy (SCP)-based Third Generation Partnership Project (3GPP) communication model D routing, the system comprising:
a combined roaming hub, network function (NF) repository function (NRF), and SCP deployment including at least one processor;
a plurality of SEPP instances, an NRF instance, and an SCP instance implemented by the at least one processor;
the SEPP instances for registering, with the NRF instance, NF profiles of the SEPP instances, wherein the NF profiles each include a list of at least one identifier of at least one public land mobile network (PLMN) reachable through a registering SEPP instance;
the SEPP instances for heart-beating with the NRF instance; and
the SCP instance for obtaining, from the NRF instance, NF profiles of the SEPP instances in the combined roaming hub, NRF, and SCP deployment and using the NF profiles of the SEPP instances, including the lists of identifiers of at least one PLMN reachable through the SEPP instances, to route SBI request messages between the SEPP instances according to 3GPP communication model D.

12. The system of claim 11 wherein the SCP instance is dedicated to routing messages between the SEPP instances of the roaming hub.

13. The system of claim 11 wherein the SEPP instances are configured to register with the NRF instance by transmitting NF register request messages to the NRF instance and the NF register request messages each include a SeppInfo attribute containing the list of at least one identifier of at least one PLMN reachable through a registering SEPP instance.

14. The system of claim 11 wherein the SEPP instances are configured to heart-beat with the NRF instance by transmitting NF heart-beat request messages to the NRF instance and the NF heart-beat request messages each carry information indicative of a current processing load of a heart-beating SEPP instance.

15. The system of claim 11 wherein the SCP instance is configured to obtain the NF profiles of the SEPP instances deployed within the roaming hub by transmitting an NF list retrieval request message to the NRF instance, receiving, from the NRF instance, an NF list retrieval response message including a list of identifiers of the SEPP instances within the combined roaming hub, NRF, and SCP deployment, transmitting, to the NRF instance, an NF profile retrieval request message including the list of identifiers of SEPP instances; and receiving, from the NRF instance, NF profiles of the SEPP instances identified in the list.

16. The system of claim 11 wherein the SCP instance is configured to receive an SBI request message addressed to a target PLMN and to obtain the NF profiles of the SEPP instances by transmitting, to the NRF instance, an NF discovery request message including a query parameter identifying the target PLMN and receiving, from the NRF instance, an NF discovery response message, and reading, by the SCP instance and from the NF discovery response message, an NF profile of at least one of the SEPP instances through which the target PLMN is reachable; and
the SCP instance is configured to use the NF profiles to intelligently route SBI request messages by reading the list of at least one identifier of at least one PLMN in the NF profile received in the NF discovery response message and forwarding the SBI request message to a SEPP instance through which the target PLMN is reachable.

17. The system of claim 11 wherein the SCP instance is configured to obtain NF profile updates of the SEPP instances.

18. The system of claim 17 wherein the SCP instance is configured to obtain the NF profile updates by subscribing, with the NRF instance, to receive notification of updates of NF profile changes of the SEPP instances and receiving, from the NRF instance, notifications of changes in the NF profiles of the SEPP instances.

19. The system of claim 18 wherein the SCP instance is configured to receive an NF status notify request message indicating that a SEPP instance of the SEPP instances has a SUSPENDED state, and mark an NF profile of the SEPP instance stored by the SCP instance to indicate that the SEPP instance that has a SUSPENDED state.

20. 20. A non-transitory computer readable medium having stored thereon executable instructions that when executed by a processor of a computer controls the computer to perform steps comprising:
registering, by security edge protection proxy (SEPP) instances and with a network function (NF) repository function (NRF) instance in a combined roaming hub, NRF, and service communication proxy (SCP), deployment including the SEPP instances, an NRF instance, and an SCP instance, NF profiles of the SEPP instances, wherein the NF profiles each include a list of at least one identifier of at least one PLMN reachable through a registering SEPP instance;
heart-beating, by the SEPP instances and with the NRF instance;
obtaining, by the SCP instance and from the NRF instance, NF profiles of the SEPP instances in the combined roaming hub, NRF, and SCP deployment; and
using, by the SCP instance, the NF profiles of the SEPP, including the lists of identifiers of at least one PLMN reachable through the SEPP instances, to route SBI request messages between the SEPP instances according to Third Generation Partnership Project (3GPP) communication model D.
